(19) United States
(12) Patent Application Publication
(10) Pub. No.: US 2024/0340161 A1
(43) Pub. Date: Oct. 10, 2024

(54) APPARATUS, METHOD, AND SYSTEM

(71) Applicant: Intel Corporation, Santa Clara, CA (US)

(72) Inventors: Ofer RIVLIN, Tel-Aviv (IL); Dan HOROVITZ, Rishon Lezion (IL)

(21) Appl. No.: 18/531,786

(22) Filed: Dec. 7, 2023

(51) Int. Cl. H04L 9/08; H04L 9/00; H04L 9/32

(52) U.S. Cl. CPC H04L 9/0825; H04L 9/008; H04L 9/3236

(57) ABSTRACT

It is provided an apparatus comprising interface circuitry, machine-readable instructions, and processing circuitry to execute the machine-readable instructions. The machine-readable instructions comprise instructions to encrypt data of a first agent with a homomorphic public key. The first agent is connected to a network. The machine-readable instructions further comprise instructions to transmit the encrypted data of the first agent and the homomorphic public key to a server and to request data from the server, the requested data comprising a reference value for the data of the first agent. The reference value is based on the data of the first agent and on the data of one or more second agents, the one or more second agents are connected to the network. The machine-readable instructions further comprise instructions to receive the requested data from the server. The requested data is encrypted with the homomorphic public key.

### BACKGROUND

The collection of private data, which includes personal information, offers many opportunities, such as the potential to gain data-driven insights and improve various aspects of an organization or business. These insights can support data analysis, collaborative data processing and informed decision making, fundamentally improving efficiency, and enabling strategic progress. However, this pursuit comes with a complex set of challenges, primarily related to data privacy and regulatory compliance. Personal data, ranging from precise geographic information to user-specific details, carries inherent risks, including unwanted identity disclosure and unwarranted persecution. Finding a balance between data utility and strict privacy regulations may be difficult.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus or device;

FIG. 2a illustrates a homomorphic encryption cryptography process;

FIG. 2b illustrates a homomorphic encryption cryptography process;

FIG. 3 illustrates a block diagram of an example of a second apparatus or device;

FIG. 4 illustrates a block diagram of an example of a system;

FIG. 5 illustrates a diagram of between a received signal strength indicator (RSSI) and a distance of an agent;

FIG. 6 illustrates a system;

FIG. 7 illustrates an example flow as carried out by the system;

FIG. 8 illustrates a communication between the first client and the data lake secured by homomorphic encryption cryptography;

FIG. 9 illustrates a flowchart of an example of a method; and

FIG. 10 illustrates a flowchart of an example of a method.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

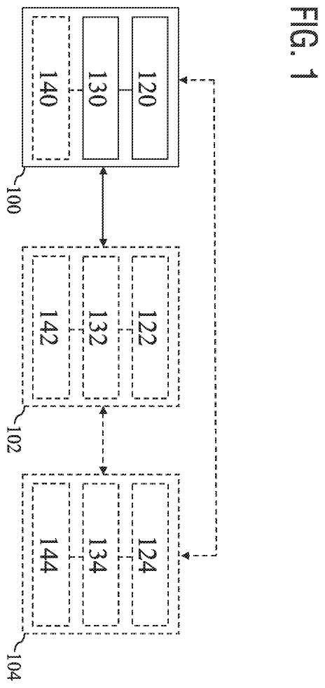

FIG. 1 illustrates a block diagram of an example of an apparatus 100 or device 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and optionally with the storage circuitry 140.

For example, the processing circuitry 130 may be configured to provide the functionality of the apparatus 100, in conjunction with the interface circuitry 120. For example, the interface circuitry 120 is configured to exchange information, e.g., with other components inside or outside the apparatus 100 and the storage circuitry 140. Likewise, the device 100 may comprise means that is/are configured to provide the functionality of the device 100.

The components of the device 100 are defined as component means, which may correspond to, or implemented by, the respective structural components of the apparatus 100. For example, the device 100 of FIG. 1 comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

For example, the apparatus 100 may be connected to a second apparatus 102 and/or third apparatus 104. The second apparatus may comprise a second processing circuitry 132, a second interface circuitry 122 and/or a second storage circuitry. The third apparatus 104 may comprise a third processing circuitry 134, a third interface circuitry 124 and/or a third storage circuitry 144.

The interface circuitry 120/122/124 or means for communicating 120/122/124 may correspond to one or more inputs and/or outputs for receiving and/or transmitting information, which may be in digital (bit) values according to a specified code, within a module, between modules or between modules of different entities. For example, the interface circuitry 120122/124 or means for communicating 120122/124 may comprise circuitry configured to receive and/or transmit information.

For example, the processing circuitry 130/132/134 or means for processing 130132/134 may be implemented using one or more processing units, one or more processing devices, any means for processing, such as a processor, a computer or a programmable hardware component being operable with accordingly adapted software. In other words, the described function of the processing circuitry 130132/134 or means for processing 130132/134 may as well be implemented in software, which is then executed on one or more programmable hardware components. Such hardware components may comprise a general-purpose processor, a Digital Signal Processor (DSP), a micro-controller, etc.

For example, the storage circuitry 140/142/144 or means for storing information 140142/144 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

The processing circuitry 130 is configured to encrypt data of a first agent with a homomorphic public key. The first agent is connected to a network. For example, the first agent may be implemented by the apparatus 100. In another example, the first agent may comprise the apparatus 100.

The processing circuitry 130 is further configured to transmit the encrypted data of the first agent and the homomorphic public key to a server. For example, the first agent may be implemented by the apparatus 100 or the first agent may comprise the apparatus 100.

The processing circuitry 130 is further configured request data from the server. The requested data comprising a reference value for the data of the first agent. The reference value is based on the data of the first agent and on the data of one or more second agents. The one or more second agents are connected to the network. For example, one or more or all of the one or more second agents may be implemented by the third apparatus 104.

The processing circuitry 130 is further configured to receive the requested data from the server, the requested data is encrypted with the homomorphic public key.

The reference value for the data of the first agent may be data that is comparable to data of the first agent. The reference value for the data of the first agent can be a value that can be set in relation to data of the first agent. The first agent may comprise a parameter that can relate to the same measured variable as the reference value for the data of the first agent, and therefore the reference value for the data of the first agent can serve as a reference value or comparison value for the first agent. For example, the reference value for the data of the first agent can be specified in the same unit of measurement as the corresponding parameter of the first agent and thus serve as a reference value or comparison value. This means that the reference value for the data of the first agent may be compared with the corresponding value of the first agent, whether it is greater or less than a corresponding value of the first agent. The reference value for the data of the first agent may be data which is used to adjust a parameter of the first agent.

For example, the reference value may comprise a value based on a summation of the data of the first agent and on the data of the one or more second agents. For example, the reference value may comprise an average value of the data of the first agent and on the data of the one or more second agents.

In some examples, the reference value for the data of the first agent may also be reference value for each of the data of the one or more second agents.

The requested data from the server and/or reference value for the data of the first agent may be based on the data of the first agent and on the data of one or more second agents. For example, the data of the first agent and the data of the one or more second agents indicate a measurement value of a same parameter with respect to the respective agent. For example, the reference value for the data of the first agent is an average or sum or the like of all the measurements.

The requested data from the server comprises the reference value for the data of the first agent and may further comprise other data, like metadata or the like.

Further, the processing circuitry 130 may be configured to adjust a parameter of the first agent based on the reference value from the server. The parameter that is adjusted may be a technical parameter (for example an internal control and/or operation setting of the agent). For example, the parameter may be a parameter that is related to the control of the first agent within the network or with regards to the one or more second agents, or the technical operation and control of the first agent. For example, the parameter may be adjusted by increasing or decreasing it such that the parameter is controlled towards the reference value for the data of the first agent.

The network may be a structured system that connects and facilitates communication between various network participants (for example agents), which can include devices (e.g., computers, hardware, software, smartphones, cars). The network enables network participants to interact and share data over wired or wireless connections, encompassing a wide spectrum of applications, from computer networks, radio networks, and the internet to transportation networks like vehicle communication systems. The network may comprise equal and identical participants or there may be one or more distinguished network participants with a leadership and coordination role and corresponding guided network participants. For example, the network may be constituted by an access point and computers connected to that access point.

An agent (for example, the first agent, or the one or more second agents) may be a network participant in the network. For example, the agent may be a software program, device, or entity that operates autonomously or semi-autonomously, representing a specific function or role within the network.

The network may comprise one or more second agents. For example, a second agent may be implemented or may comprise a second apparatus 102. The second apparatus may comprise second interface circuitry 122, second processing circuitry 132 and (optional) second storage circuitry 142. The components of the second apparatus 102 may be implemented different or similar as the components of the apparatus 100.

In one example, the first agent and parts or all of the one or more second agents may be communicatively coupled to each other. For example, the second interface circuitry 122 of the second apparatus 102 may be communicatively coupled to the interface circuitry 120 of the apparatus 100. In another example, the first agent and the one or more second agents may all be communicatively coupled to one central instance in the network.

All or some participants of the network, for example the first agent and the one or more second agents may be connected to the server. In one example, the server is considered part of the network. In another example, the server is not considered part of the network. The server may be implemented by the second apparatus 102 or the server may comprise the second apparatus 102.

The server may be a hardware or software system (for example a virtual machine) that provides data, resources, services, or programs to the first and the one or more second agents.

In some examples, the server may be separated. Separating the server may refer to the principle of dividing the functions, services, or resources of the server into distinct elements to enhance efficiency, security of the shared data and enable the agents to adjust their technical parameters based on securely shared and received data. The separation may be done physically, by using multiple apparatuses for different tasks, or virtually, through techniques like virtualization, where a single physical server is divided into multiple isolated virtual servers or logically.

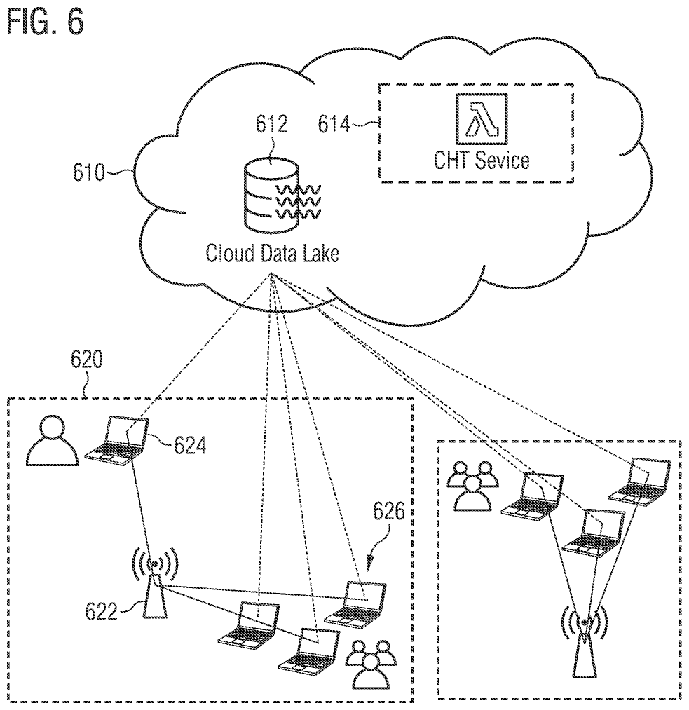

In some examples, the server may be separated by comprising two or more distinctly controllable apparatuses (wherein each apparatus may comprise processing circuitry, interface circuitry and/or storage circuitry). In this case a first apparatus of the server (for example the second apparatus 102) may act as an intermediary between the agents and a second apparatus of the server. There may be no direct communication between the agents and the second apparatus of the server. The second apparatus of the server may carry and execute the transmitting, requesting, receiving, and generating of the server. The first apparatus of the server may control the data storage/cloud storage or the like and may act as the intermediary (for example the data lake in FIG. 6 below).

In some examples, the server may be separated by comprising a software application and/or a virtual machine that controls and executes the steps as describe above (transmitting, receiving, requesting etc.) and another application that controls for example the data storage and the hardware of the server. The operator of the data storage and the hardware of the server may have no access to the received, transmitted, and stored data that.

In some examples, there may be combination of the two above described alternatives, wherein some hardware and circuitries may be shared, and different software application are operated.

Further, the agents within the network may not directly communicate with each other but only communicate through the server (for example through the first or second apparatus of the server). This may be referred to as segregation. This may further increase the security of the shared data and enable the agents to adjust their technical parameters (for example internal control and/or operation settings) based on securely shared and received data.

That is the private data of the first agent and the one or more second agent is encrypted at the respective first agent and the one or more second agents' side and is being computed on the central server side using homomorphic encryption cryptography. This enables sharing by the agent's identifiable data with the centralized computation server (cloud side not need to encrypt, keep, maintain, address regulations as GDPR on that data) with no need for protecting that data from privacy perspective. Therefore, the above described technique may be applied by organizations (e.g., report on faulty APs, load connectivity per area, etc.) without compromising the privacy of any of the users. Further, the above described technique enables collaboration of the agents without compromising their privacy (e.g., enables each client/agent to have a view of the ad-hock network it is connected to—identified on added/removed devices, disrupting protocols like Video streams, etc. without compromising anyone's privacy—and make connectivity changes accordingly). That may be relevant with regards to specific laws or regulations such as obligations under Article 5(2) of the GDPR (General Data Protection Regulation). With the above described technique, the agent doesn't need to approve sharing their PII and still the insights the agents receives are based on such. The server doesn't know who the participants and their data are shared anonymized and encrypted at user side.

Further, with previous approaches each agent may only see the parameters of its own connection, but not of the whole immediate network and any other connections and paths. By using the technique described, all the agents may get a broad view of the immediate network which they are connected to, and this is done without compromising the privacy of any of them. This broad network view may be achieved by having the combination (and only the combination) of the views of each of the agents on the specific interesting network parameters, without accessing the private view of the agent itself. Having such a broad view enables the agents to adjust their parameters and/or optimize and/or take intelligent decisions regarding their connection and/or the communication (e.g., change protocol, change channel, change distance/place or angel, etc.).

In other words, the above described technique enables an agent to share data (for example telemetry data or other collected data) comprising personally identifiable-information (PII) and receive a reference value that may be used to adjust a technical parameter (for example an internal control and/or operation setting of the agent) of the agent and improve is operations without exposing the data to the central server, or other agents.

This may further enable users that to use telemetry and improve data-driven their technical systems with PII without compromising their privacy and without compromising the privacy of any of the users.

In other words, the distributed collaborative privacy preserving technique sharing of data for centralized computation as described above enables distributed individual clients to anonymously connect (represented as a generated random ID per client and/or changing ID per sharing session) to a centralized server. It further enables to upload/share anonymized and encrypted information for shared computation (using homomorphic encryption and the requesting-client's public key). Any participant client may also download the aggregated results computed from all participants data in that session and use it for its own benefit. The centralized authority maintains that network and benefits from those insights as well. This assures the privacy of the clients even if the shared data as any other information on the participants entities can identify them (even if they are not directly disclosed). Further, the technique as describe above may involve a combination of the following security architecture patterns and technologies: Separation, Segregation, Anonymization of entities, moving targets and central computation on encrypted data.

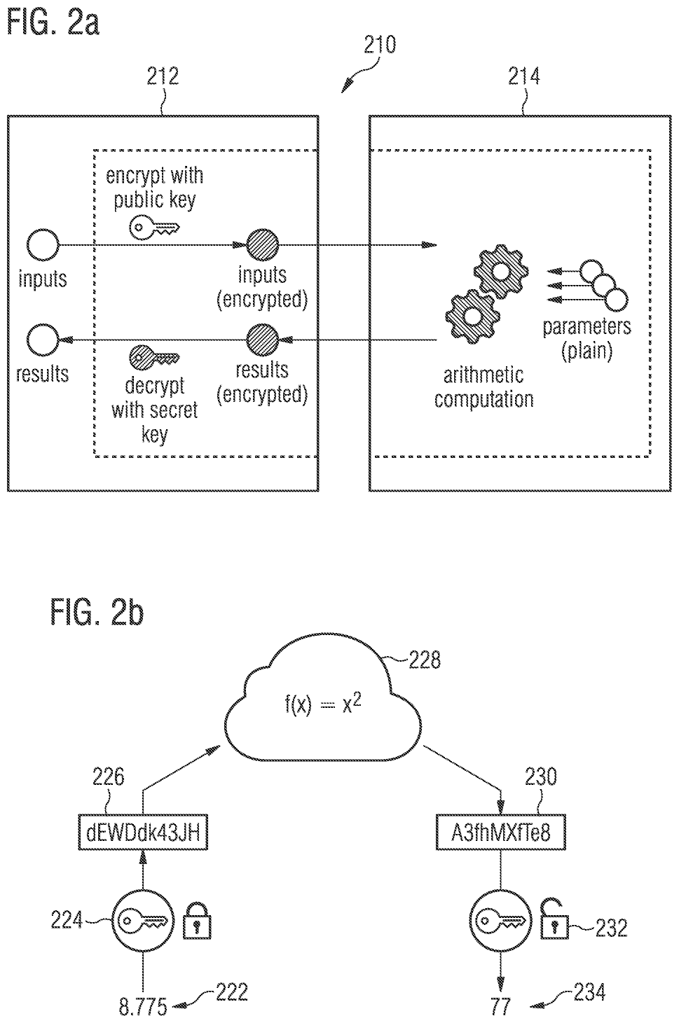

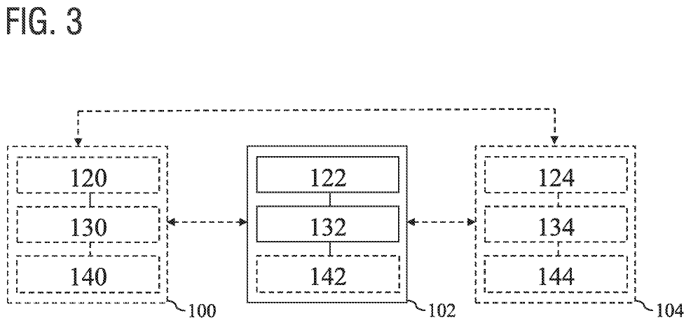

For example, the network may be a wireless network, that is enabled by an access point. For example, the first agent and the one or more second agents are wireless network agents, connected to the access point. For example, a wireless access agent may a hardware and/or software in a computer that enables a wireless connection (see FIGS. 2, 3 below). For example, the first and the one or more second wireless agents may be connected to the server but not the access point.

The processing circuitry may be further configured to decrypt the encrypted requested data (for example the reference value for the data of the first agent) from the server with a homomorphic private key. The homomorphic public key and the homomorphic private key forming a homomorphic key pair.

Homomorphic encryption is a form of encryption that allows computation on ciphertexts, generating an encrypted result which, when decrypted, matches the result of operations performed on the plaintext. This property enables complex calculations to be performed on encrypted data without needing to first decrypt it, which is a significant advantage for maintaining privacy and security in various computational tasks, especially in cloud computing and data sharing scenarios. Homomorphic encryption schemes are classified into three categories based on the level of operations they support: partially homomorphic, somewhat homomorphic, and fully homomorphic encryption. Each type varies in its capabilities and efficiency, with fully homomorphic encryption supporting an unlimited number of both addition and multiplication operations on ciphertexts.

In this regard, the homomorphic public key and the homomorphic private key forming a homomorphic key pair. The public homomorphic key may be used to encrypt data, while the homomorphic private key is used for decrypting any data that was encrypted with the homomorphic public key. An aspect of the homomorphic encryption is that any operations performed using the homomorphic public key (like adding or multiplying encrypted values) can be correctly decrypted using the corresponding private key, revealing the result of the same operations as if they had been performed on the unencrypted data. This allows for secure, privacy-preserving computations, where the entity performing the computation does not need access to the raw data, only the encrypted form.

Further, the processing circuitry 130 may be configured to transmit the decrypted requested data back data to server. The server may then transmit the decrypted requested data to the one or more second agents. Each of the one or more second agents may adjust a respective technical parameter (for example an internal setting of each of the one or more second agents) as described with regards to the first agent) without exposing their data to the central server, or other agents.

FIG. 2a illustrates a homomorphic encryption cryptography process. For example, a Brakerski-Fan-Vercauteren (BFV) scheme or a Cheon-Kim-Kim-Song (CKKS) may be used (security and functionality parameters). First a public-private (secret) key pair is generated (maybe also other keys such as evaluation, re-linearization etc.). Then may be a plaintext input is transferred into plaintext-polynomials (for example using numpy vectors) on an user's side 212 (for example by the first agent). Then an input is encrypted into ciphertext with the public key on the user's side 212 (for example by the first agent). Then ciphertext is transmitted to a server 214, for example a cloud service provider. At the server side computations may be carried out on the ciphertext, for example based on plaintext parameters. Then the encrypted computation results are transmitted from the server 214 back to the user side 212. The encrypted computation results may be decoded and the decoded into plaintext-polynomials (for example numphy vectors). The into plaintext-polynomials may finally be decrypted using the private (secret) key to obtain a plaintext result. Thereby, for example, sensitive computations may be outsourced a server, for example a cloud service provider without the risk of being disclosed.

FIG. 2b illustrates a homomorphic encryption cryptography process. An input 222 (the value 8.775) is encrypted by a user with a private key 224. The private key 224 is part of a public-private key pair 224, 232. The encrypted input 226 is transmitted to a server, 228, for example a cloud service provider. Computations are performed on the encrypted input. The result of the computation 230 are transmitted back to the user or any other person that has access to the private key 232. The computation result 230 is decrypted by the private key 232 to obtain the decrypted result 234.

Further, the processing circuitry 130 may be configured to generate a random identifier for communication between the first agent and the server. Further, the one or more second agents may also each generate a random identifier for communication with the server. That is the server may only identify the agents by the randomly generated identifier. That is the communicating between the agents and server is based in the randomly generated identifier. Therefore, the first agent and the one or more second agents and the data that is shared by these agents are anonymized and there may be no conclusions on the specific operator or location, or the like of the agents be possible by the server. The server receives data that comprises information that is used to determine the reference value for the data of the first agent, however without being able to further identify the agent that or information about the agent that delivered the data.

Further, if the clients communicate among each other, they may also communicate based on the random identifier and therefore have no further information on the communication partner. The random identifier may be re-generated on regular or irregular occasions. For example, a random identifier may be re-generated in pre-determined time intervals, for example once a day or once per hour or once per minute or the like. For example, a random identifier may be re-generated for every session between the agent and the server or between the agent and a network that it is connected to. Further, each agent's/client's random identifier may be changed with every connection to the server, so there may be no way to follow one agent/client identifier on the backend.

Therefore, the above described technique further anonymizes the agents and further removes the need to protect agents' data. The clients aren't required to provide consent to share PII as the data that is shared is anonymized. That is the data of the first agent and the data of the one or more second agents still comprises information that is used to determine the reference value for the data of the first agent, however without being able to further identify the agents or information about the agents that delivered the data. Therefore, the user/agent may not need to approve sharing his PII comprising data, because all the data is anonymized. Many agents/users may be privacy sensitive and by default would not share their PII through telemetry and therefore would not share data (e.g., telemetry) at all. The above described technique enables an agent to anonymously share data and receive a reference value that may be used to adjust a technical parameter of the agent without exposing the data to the central server, or other agents. Thereby, the technical parameter of the agent may be adjusted in an improved and efficient manner.

Further, the above described technique may provide anonymization of the first agent and the one or more second agents of the clients and access points using random IDs generated per session. Data may be stored temporarily per session and the user can actively delete his information.

Therefore, the above described technique provides a way to share and use data (for example telemetry data or other collected data) comprising personally identifiable-information (PII) without exposing the privacy of the originator (e.g., the first agent and the one or more second agents) of the data. That may be relevant with regards to specific laws or regulations such as obligations under Article 5(2) of the GDPR (General Data Protection Regulation).

In some examples, the processing circuitry 130 may be configured to generate a network identifier, the network identifier identifying all agents being connected to the network and the network identifier being included in the data of first agent. For example, the network identifier may be included also in the data of the one or more second agents. For example, the network identifier may be a random number. Additionally, or alternatively the network identifier may comprise temporary information like date for instance. For example, all agents being connected to the network are also connected to the server and provide (for example transmit) to the server, said network identifier. As described above the server may receive the request by the first agent to determine the reference value for the data of the first agent. The server may then check for all agents that are in communication with the server if they provided said network identifier. For all agents for which this is the case (for example the one or more second agents), the server may request and receive the data of the one or more second agent.

For instance, the network may a wireless network. For example, the wireless network may be a wireless local area network (WLAN) network or a cellular network or a Bluetooth network or the like. For example, the first agent and the one or more second agents may WLAN agents.

For instance, if the agents are WLAN agents, the technical parameter that is adjusted based on the reference value may be at least one of the following: Adjusting the transmit power of the WLAN module, adjusting the roaming aggressiveness to high, selecting another (for example 5 GHz) band, ensuring drivers are up-to-date, adjusting power management settings for optimal performance, disabling interfering applications, using WLAN analyzer tools for optimal channel selection.

In some examples, the network is a network provided by an access point. An access point may be a device that connects the first agent and the one or more second agents wirelessly to the network. The access point may provide the WLAN and the agents may be WLAN agents. The access point itself may be further connected to another network, for example, the internet or the like and thereby acting as a bridge between the wireless and wired segments. It allows the agents (for example devices like laptops, smartphones, and tablets) to connect to the network and, by extension, to the other network such as the internet without the need for physical cables. The access point may provide a wireless network between the first agent and the one or more second agents.

The data of the first agent and the data of the one or more second agents may comprise a respective signal strength value of a respective signal connection between the respective agent and an access point providing the network. For example, the access point provides a WLAN and the agents may be WLAN agents. The data of the first agent may be signal strength between the first agent and the access point. The data of the one or more second agents may be respective signal strength between the respective one or more second agent the access point. For example, the signal strength may be a Received Signal Strength Indicator (RSSI), which is a measurement used in wireless networking to indicate the strength of the signal received by an agent/client device from a wireless access point or router. RSSI may be measured in decibels relative to a milliwatt (dBm) and is used as a rough indicator of the quality of the wireless connection.

In some examples, the reference value may be an average value of the signal strength values of the signal connections between the agents and the access point. For example, the reference value may be an average value of the RSSI of the connection between the first agent and the access point and the one or more second agents and the access point. In another example, the reference value may be an average value of the signal strength values of the signal connections between the one or more second agents and the access point. For example, the reference value may be an average value of the RSSI of the connection between one or more second agents and the access point.

In some examples, the processing circuitry may be further configured to generate a hash code corresponding to the access point, the hash code identifying all agents connected to the wireless network and the hash code being included in the data of the first agent. In some examples, the hash code may be also included in the data of the one or more second agents. For example, the hash code may be based on a service set identifier (SSID) or basic service set identifier (BSSID) or a marker and/or a model or the like of the access point. For example, all agents that connect to the access point connect to the server and the provide (for example transmit) to the server, the hash code corresponding to the access point. Additionally, or alternatively to the hash value the provided information may further compromise temporary information like date for instance. As described above the server may receive the request by the first agent to determine the reference value, for example the average value of the signal strength of all agents that are connected to the access point. The server may then check for all agents that are in communication with the server if they provided the hash code corresponding to the access point. For all agents for which this is the case (for example the one or more second agents), the server may request and receive the data of the one or more second agents, that is their respective signal strength.

Enables each client to have a view of the ad-hock network it is connected to (identified on added/removed devices, disrupting protocols like Video streams, etc. without compromising anyone's privacy), and make connectivity changes accordingly. Data is also stored temporarily per session and the user can actively delete his encrypted/anonymized information.

Further details and aspects are mentioned in connection with the examples described below. The examples shown in FIGS. 1, 2a, 2b 2 may include one or more optional additional features corresponding to one or more aspects mentioned in connection with the proposed concept or one or more examples described below (e.g., FIGS. 3-10).

### Server

FIG. 3 illustrates a block diagram of an example of a second apparatus 102 or device 102. The second apparatus 102 comprises circuitry that is configured to provide the functionality of the apparatus 102. For example, the second apparatus 102 of FIG. 3 comprises second interface circuitry 122, second processing circuitry 132 and (optional) second storage circuitry 142. For example, the second processing circuitry 132 may be coupled with the second interface circuitry 122 and optionally with the second storage circuitry 142. The second apparatus 102 of FIG. 3 and its components may be implemented identical to the apparatus 102 of FIG. 1 and its components.

For example, the second apparatus 102 may be connected to the apparatus 100 and/or the third apparatus 104. The apparatus 100 and the third apparatus 104 of FIG. 3 and their components may be implemented identical to the apparatus 100 and the third apparatus 104 of FIG. 1 and their components.

The second processing circuitry 132 is configured to receive a request from a first agent to generate data. The requested data comprising a reference value for data of the first agent connected to a network. The reference value for the data of the first agent is based on the data of the first agent and on data of one or more second agents, the one or more second agents being connected to the network.

In some examples, the reference value for the data of the first agent may also be reference value for each of the data of the one or more second agents.

The second processing circuitry 132 is further configured to receive a homomorphic public key and encrypted data of the first agent. The data of the first agent encrypted with the homomorphic public key from the first agent.

The second processing circuitry 132 is further configured to determine a list of the one or more second agents which are connected to the network.

The second processing circuitry 132 is further configured to transmit the homomorphic public key to the one or more second agents.

The second processing circuitry 132 is further configured to request and receive encrypted data of the one or more second agents. The second processing circuitry 132 is further configured to generate the requested encrypted data based on the encrypted data of the one or more second agents.

For example, the processing circuitry 132 may receive from each of the one or more second agents the respective encrypted data and may generate based on this data the reference value and/or the requested data.

In some examples, the second processing circuitry 132 is configured to transmit the encrypted data of the first agent (or a transformation of this data), which may be referred to as the current reference value, to a first agent of the one or more second agents. The first of the one or more second agents may transform the received encrypted current reference value by including its data into the current reference value by using the public key. This may yield an updated reference value which may transmitted back to and received by processing circuitry 132 as a new current reference value. Then the processing circuitry may again transmit the encrypted new current reference value, to a second agent of the one or more second agents. The second of the one or more second agents may transform the received encrypted current reference value by including its data into the current reference value by using the public key. This may yield a new updated reference value which may transmitted back to and received by processing circuitry 132. This process may be repeated sequentially for all of the one or more second agents. Then the processing circuitry 132 may generate based on last received updated reference value this data the (final) reference value and/or the requested data. In some examples, the two alternatives explained above are combined.

The second processing circuitry 132 is further configured to transmit the decrypted requested data to the one or more agents.

For example, there may further apparatus (which may comprise processing circuitry, interface circuitry, and/or storage circuitry) placed between the second apparatus 102 and the agents. For example, all data is received and stored and transmitted from the further apparatus, wherein the second apparatus 102 controls the transmitting, requesting, receiving, and generating as described above. The further apparatus may store the data and act as an intermediary. There may be no direct communication between the clients and the second apparatus 102 This concept is referred to as separation as described above.

For example, the second apparatus 102 may be a server as described with regards to FIG. 1 above. For example, the server may comprise the second apparatus 102 and the further apparatus as explained in the previous paragraph. In some examples, the separation may be done by running two or more distinct software applications and/or virtual machines on the apparatus 102. For example, one software applications and/or virtual may control the transmitting, requesting, receiving, and generating and the other may control the storing of the data and the like.

Separating the server may refer to the principle dividing the functions, services, or resources of the server into distinct elements to enhance efficiency, security of the shared data and enable the agents to adjust their technical parameters based on securely shared and received data.

All or some participants of the network, for example the first agent and the one or more second agents may be connected to apparatus 102. In one example, apparatus 102 is considered part of the network. In another example, apparatus 102 is not considered part of the network. example, the first agent may be implemented by the apparatus 100. In some examples, the first agent may comprise the apparatus 100. For example, one or more or all of the one or more second agents may be implemented by an apparatus as the third apparatus 104.

Further, the agents within the network may not directly communicate with each other but only communicate through the apparatus 102 (for example the second interface circuitry 122 or second processing circuitry 132 or second storage circuitry 142) or the intermediary. This may be referred to as segregation. This may further increase the security of the shared data and enable the agents to adjust their technical parameters based on securely shared and received data.

The reference value may be used to adjust a parameter of the first agent based on the reference value. Alternatively, or additionally the reference value may be used to adjust a respective parameter of one or all of the one or more second agents. The parameter that is adjusted may be technical parameter. For example, the parameter may be a parameter that is related to the control of the first agent or to the control of a respective agent of the one or more second agents within the network. For example, the parameter may be adjusted by increasing or decreasing it such that the parameter is controlled towards the reference value.

That is the private data of the first agent and the one or more second agent is encrypted at the respective first agent and the one or more second agents' side and the reference value is determined by the second apparatus 102 using homomorphic encryption cryptography. This enables sharing by the agent's identifiable data with the second apparatus 102 with no need for protecting that data from privacy perspective. Therefore, the above described technique may be applied by organizations like server operators (e.g., report on faulty APs, load connectivity per area, etc.) without compromising the privacy of any of the users. Further, the above described technique enables collaboration of the agents without compromising their privacy. That may be relevant with regards to specific laws or regulations such as obligations under Article 5(2) of the GDPR. With the above described technique, the apparatus 102 doesn't need to ask for approval from the agents before they are sharing their PII and still be able to collect and provide insights to the agents. The apparatus 102 doesn't know who the participants and their data are because the data is anonymized and encrypted at agents' side. In other words, the above described technique enables the apparatus 102 to collect data (for example telemetry data or other collected data) comprising personally identifiable-information (PII) and provide a reference value to agents, which may be used to adjust their respective technical parameter without collecting personal data or exposing or other agents.

For instance, if the agents are WLAN agents, the technical parameter that is adjusted based on the reference value may be at least one of the parameters as described above. Alternatively, or additionally at least one of the following parameters of the access point may be adjusted: Adjusting the wireless channel to reduce interference, updating its firmware for enhanced performance, adjusting antenna positions for better coverage, and utilizing advanced features like Quality of Service (QOS) settings to prioritize traffic. Further, by mapping the access-point parameters (average quality, load, etc.), the cloud service can recommend to agents which network to connect to.

For example, the processing circuitry 132 is configured to transmit the encrypted requested data to the first agent. Further, the processing circuitry 132 may be configured to receive the decrypted requested data from the first agent.

For example, the processing circuitry 132 is configured to add a random number to the encrypted data of the first agent. For example, the processing circuitry 132 subtracts the random number from the encrypted requested data. For example, the random number is added to first data before it is transmitted to the first agent of the one or more second agents as the reference value as described above. This may further increase the security of the transmitted reference value.

For example, the data of the first agent and the data of the one or more second agents may comprise a network identifier, the network identifier identifying all agents connected in the network.

For instance, the data of the first agent and the data of the one or more second agents comprise a respective signal strength value of a respective signal connection between the respective agent and an access point providing the network.

For example, reference value is an average value of the signal strength values of the signal connections between the agents and the access point.

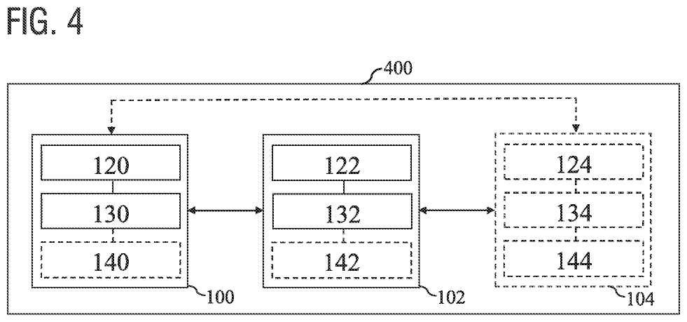

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1, 2) and below (e.g., FIGS. 4-10).

### System Comprising Agents and Server

FIG. 4 illustrates a block diagram of an example of a system 400. The system comprises a first apparatus 100 as described above. The system 400 further comprises a second apparatus 102 as describe above. The system may optionally comprise a third apparatus 104 as described above.

The system may comprise a first agent comprising the apparatus 100 as described above. The system 400 may further comprise a server comprising the apparatus 102 as described above.

The server may further comprise another apparatus that may act as an intermediary as described above.

The system may further comprise one or more second agents that may comprise an apparatus as the third apparatus 104.

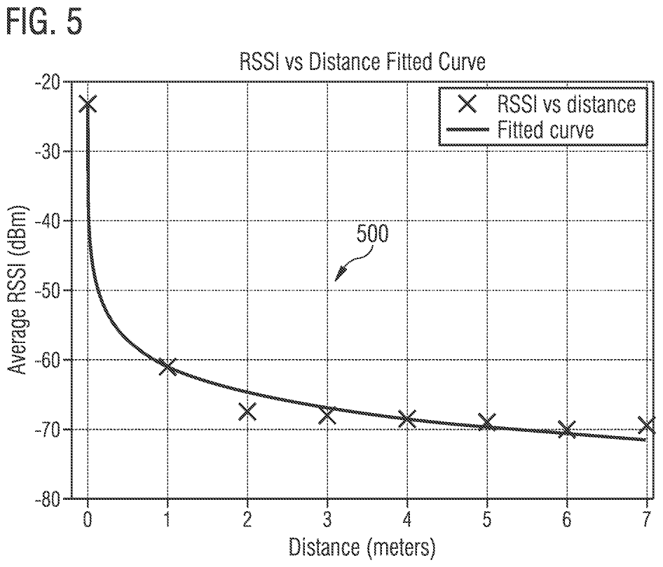

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) and below (e.g., FIGS. 5-9).

### Application Example

Some examples of the above described computation (for example cloud computation) on collected sensitive private data from telemetry agents may relate to Wi-Fi agents on PCs for instance, robots or cars (VANETs—vehicular ad-hoc networks), for data analysis and for performing collaborative computation. The collaborative computation results may be consumed by the client agents for instance to improve performance, or by the servers for various further decisions. As described above due to privacy regulations, this collected data may be considered sensitive PII.

For instance, in cars the location may identify users. In some use cases due geo specific privacy regulation, the data can't be shared to a centralized entity without user consent, or it is tried to keep it anonymized by choice and not to handle it as PII. In other use cases the data should be combined cross geo and that is also problematic. This private data must not be shared with the cloud or with any other client or entity but only used for generic computations and not specific to a unique client.

For instance, a user connects his computer to a public Wi-Fi access point (e.g., at a neighborhood café or the like). A utility on the computer wants to assess the quality level of its connection to this access point by a comparison against the average quality level of the current other connected users to that access point (such information can tell if there is an issue with the client's Wi-Fi or with the access point for instance). However, in this case, it may be considered sensitive data who are the clients that share the same access point, the access point AP itself and each client's signal quality. For instance, an access point location is known (either it is public knowledge, or it is known to an organization), together with the information of a client's signal quality, this data exposes the users' exact physical location, and enables physical tracking of users (precise geolocation is classified at Intel as Sensitive confidential personal data). However, in improve and adjust the Wi-Fi connection or parameters related to it (e.g., by a cloud health-tool), it is important to collected data from Wi-Fi agents. This is also described with regards to FIG. 5.

FIG. 5 illustrates a diagram of between a RSSI and a distance of an agent. The crosses show a measured distance between an agent and an access point to which the agent is connected and a respective RSSI between the agent the access point. The graph 500 is a fitted curve, fitted with regards to the measured values. The graph 500 shows that there is a clear connection between the distance between the agent and the access point and the respective RSSI. That is the RSSI level can be translated into a distance from the access point. If the server knows the location of the access point and would further receive the un-encrypted RSSI of an agent, it could determine the distance of the agent and thereby estimate the location of the client which would lead to privacy risks when calculating the average RSSI.

A prior approach may be using a server (e.g. a cloud service) that collects connection information from all the client PCs. The cloud service can then find all the PCs that share the same access point and calculate the average quality of their connection. However, the problem with this solution would be that it puts the privacy of users at risk (i.e., who are the clients and their exact physical location in the Wi-Fi example). The privacy risk in such scenarios is not only the data that the clients' share, but also the identification of the clients themselves and the access point they connect to. The technique as described above and below enables the above scenario while keeping complete privacy of any information on the users, their PCs and their data Further, the encryption of the data of a first agent and also of the data of one or more second agents may ensure, that a server may not draw conclusions on the agents, for example on their location as illustrated with regards to FIG. 5.

FIG. 6 illustrates a system 600. The system 600 comprises a server 610. The server comprises a data-lake 612. The data-lake may be provided a cloud infrastructure. Further, the server 610 comprises an application service 614. In one example, the data lake 612 and application service 614 may be implemented as distinct apparatuses or circuitries. In another example, the data lake 612 may provide the hardware and the application service may run as a software on the data-lake service 612. For example, the application service may a connection health tool (CHT Service). The operation of the application-service, and the operation of the data-lake infrastructure service may be separated, that is there may be no insight into data or processes from the one to the other. Further, the cloud application-service 614 has access to the data-lake 612, in order to upload and download data to and from the data-lake 612. Further, the first client 624 and the second clients 626 may not be directly with the cloud application-service 614. Further, the first client 624 and the second clients 626 may not connect with each other (segregation).

Further, the system 500 comprises a network 620. The network may be provided by an access point 622. The access point may be a shared/public Wi-Fi access point. Further, a first client 624 (for example PCs/Laptops) may be part of the network 620 and be connected to the access point 622 Wi-Fi connection. The first client 624 may comprise a first data generator, such as a first Wi-Fi connection agent manager. Further, second clients 626 (for example PCs/Laptops) may be part of the network 620 and be connected to the access point 622 for Wi-Fi connection. The second clients 626 may comprise respective second data generators, such as respective second Wi-Fi connection agent managers.

The first client 624 and the second clients 626 may each be represented by a generated random ID per session. The first client 624 and the second clients 626 are all connect with the server 614, that is with the data-lake cloud infrastructure service 612 in order to upload and download data to and from the data-lake 612. When the first client 624 and the second clients 626 connect to the data lake 612, the data lake service 614 creates a temporary directory for each of the clients on the cloud data-lake 612, with the generated random ID as the folder's name.

The access point 622 may be represented by a network identifier, for example a corresponding hash value which may be based on one or more properties of the access point 622 (e.g., SSID, BSSID, maker, or model). The access point hash may be deterministic for a certain period of time, for example an hour or a day. Additionally, or alternatively the network identifier may comprise temporary information like date for instance. The first client 624 and the second clients 626 that connect to the access point 622 may use the network identifier, for example the hash value, for a period of connecting time to the access point 622 (that is for this session) and add this network identifier under its directory on the data-lake 612.

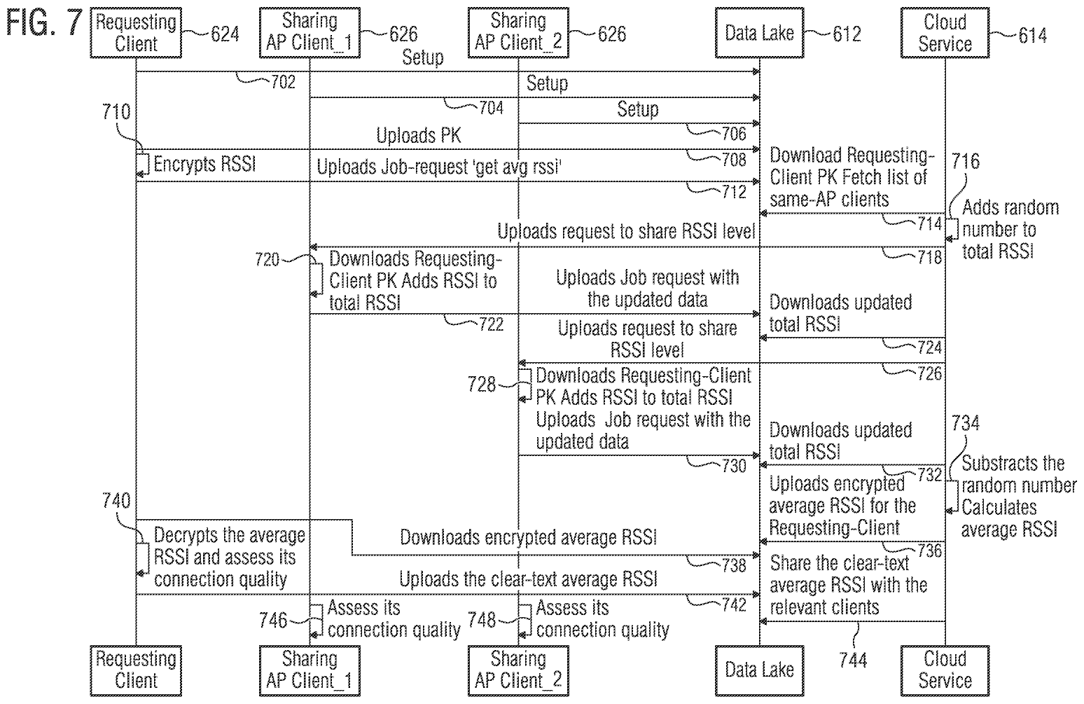

Further details and aspects are mentioned in connection with the examples described above or below. The examples shown in FIGS. 5, 6 may include one or more optional additional features corresponding to one or more aspects mentioned in connection with the proposed concept or one or more examples described above (e.g., FIGS. 1-4) and below (e.g., FIGS. 7-10).

Next, with regards to FIG. 7 a processes carried out by the system 600 and its components is described.

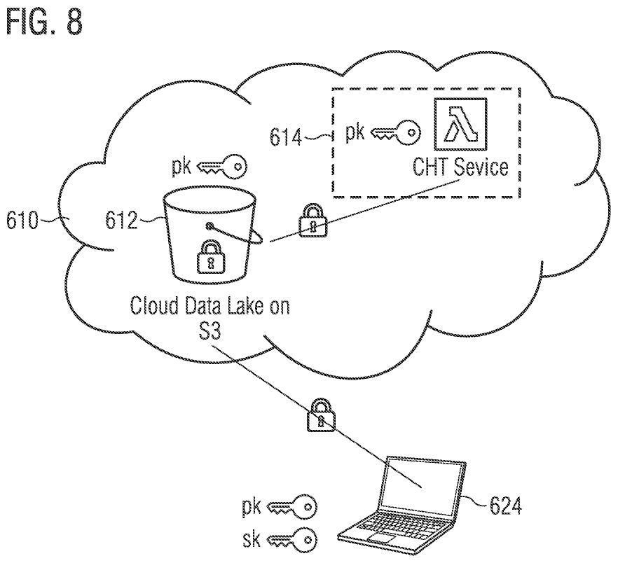

FIG. 7 illustrates an example flow as carried out by the system 600. The first client 624 (requesting client) and the second clients 626, setup 702, 704, 706 the processes as described above (generating the folders etc.). The first client 624 uploads 708 the homomorphic public key to the data lake 612. The requesting first client 624 encrypts 710 the first data, for example the value of its own connection quality RSSI, using a fully homomorphic encryption cryptography as illustrated in FIG. 8. The first client 624 uploads 712 a request to the data lake 612 to receive a reference value (e.g., aggregated data from all the clients that share the same access point 622 that it is connected to). Further, the first client 624 may then upload the encrypted first data to the data-lake 612, that stores it under the client's directory.

FIG. 8 illustrates a communication between the first client 624 and the data lake 612 secured by homomorphic encryption cryptography. The first client 624 generates a public-private (secret) key pair, pk, sk. The public key pk is uploaded to the data lake 612. The public key pk is downloaded by the application service 614 and data, for example data obtained from the second clients 626 is encrypted with the public key pk or the public key ok is shared by the application service 614 with the second clients 626 in order to encrypt data.

Back to FIG. 7. The application-service 614 downloads 714 the request from the requesting client 624 and fetches a list of all second clients 626 are connected to the same access point 622 (same access point 622 hash representation) and stores a request under the directory of each one of the second clients 626. The application-service 614 adds 716 a random number to the encrypted first data, that is to the RSSI of the first client. The application-service 614 uploads 718 the request (for example to share the RSSI level) to a first client of the second clients 726. The first client of the second clients 626 downloads 720 the public key generated by the first client 624 and may also download the reference value from the application-service 614 and add its own value to the reference value which yields an updated reference value. For example, the first client of the second clients 626 may add its RSSI value to the total RSSI value using the public key. The first client of the second clients 626 uploads 722 the updated reference value to the data lake 612. The application-service 614 downloads 724 the updated reference value, for example the updated total RSSI. The application-service 614 uploads 726 the request (for example to share the RSSI level) to a second client of the second clients 726. The second client of the second clients 626 downloads 728 the public key generated by the first client 624 and may also download the reference value from the application-service 614 and add its own value to the reference value which yields an updated reference value. For example, the second client of the second clients 626 may add its RSSI value to the total RSSI value using the public key. The second client of the second clients 626 uploads 730 the updated reference value to the data lake 612. The application-service 614 downloads 732 the updated reference value, for example the updated total RSSI. In another example, the application service 614 receives the data from the second clients and computes the reference value without transmitting the reference value to the second clients 626. The application-service 614 calculates the reference value, for example the average quality level RSSI, on the encrypted data (using homomorphic encryption and the requesting-client's public key) from the second clients 726. The application-service 614 subtracts 734 the random number from the updated reference value (for example the total RSSI) that was added before. The application-service 614 uploads 736 the encrypted reference value, for example the average RSSI, to the data lake 612 for the first client 624. The first client 624 downloads 738 the encrypted reference value. The first requesting client 626 decrypts 740 the encrypted reference value, for example the encrypted average RSSI value using its private key. The first client 626 uploads 742 the clear text decrypted reference value, for example average RSSI, to the data-lake 612. The application-service 614 shares 744 the decrypted reference value with the second clients 626 and for example places it under each of the second clients 626 folder that share the same access point 622 with the first client 624. The second clients asses 746, 748 their respective data, for example their connection quality, with regards to the reference value, for example the average RSSI. The second clients 626 may then adjust certain technical parameters in order to improve their connection quality for example if it is below average.

In the process as described above he first client 524 and the second clients 526 may not have any knowledge (for example location, IP, operator etc.) about each other. They may not even know the number of clients that share the same access point 522. The first client 524 and the second clients 526 may only receive the requested data comprising the reference value (e.g., the computed aggregated results like average connection quality level of the access point 522 they are connected to). The first client 524 and the second client's 526 clear-text data may not be shared with any other entity in the system 500. The cloud application-service 514 may have no identifiable information about the first client 524 and the second client's 526 (e.g., not the IP address, name, or any other information of the operator etc.). Furthermore, the cloud application-service 514 may have now identifiable information about the access point 522 (e.g., no name or IP or the like). The cloud application-service 514 may have no information about the number of clients that share the same access point. In another example, the cloud application-service 514 may have some information on the access point 522, such as the average signal strength quality level per week (in order to know if an access point has a low average constantly, meaning it may be faulty), average load on the access point 522 (e.g., it is too loaded or not loaded at all, such that the access point may be removed or another access point may be added to that location). However, this knowledge about the access point 522 by the cloud application-service 514 may not put any risk on the clients' privacy because the data by the first and the second clients may be anonymized, and encrypted client-side. The cloud application-service 514 may be further exposed to the receive the requested data comprising the reference value (for example the computed aggregated results like average connection quality level). The cloud application-service 514 may be operated by different organization and companies, for example operators of public access points or the like.

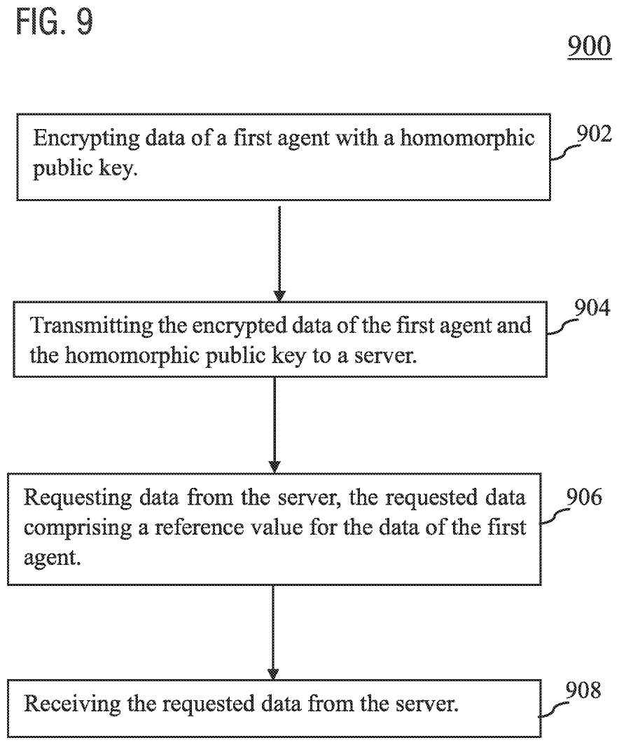

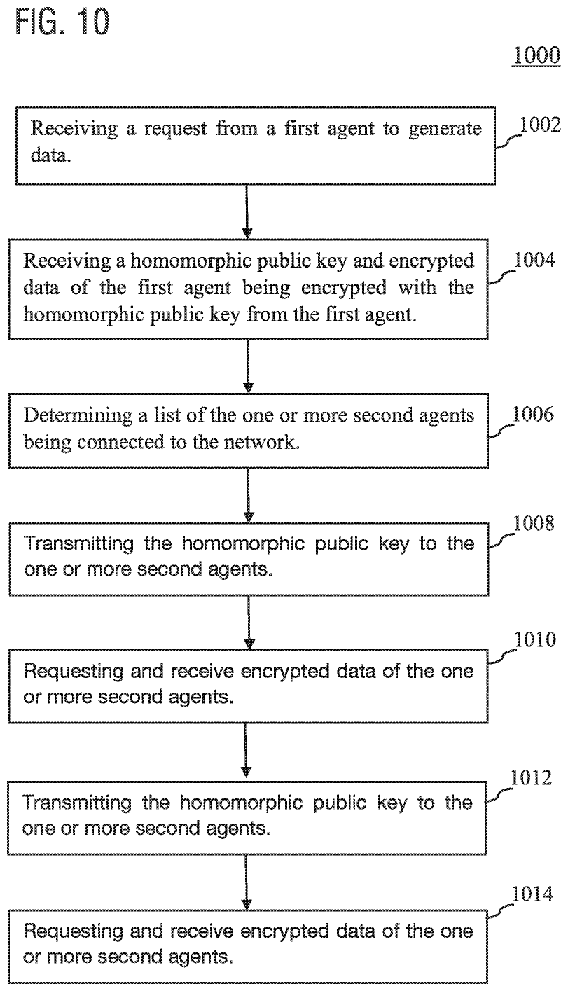

Further details and aspects are mentioned in connection with the examples described above or below. The examples shown in FIGS. 7, 8 may include one or more optional additional features corresponding to one or more aspects mentioned in connection with the proposed concept or one or more examples described above (e.g., FIGS. 1-6) and below (e.g., FIGS. 9, 10).

In some examples, a centralized computation system, e.g., cloud, may be required and clients may be connected and communicate with a centralized computing system e.g., cloud. Further, a unique agent may be installed on every client that participate in that activity. The clients aren't required to provide consent to share PII as the data used is anonymized. In some examples, a centralized computation may be detectable through the network traffic analysis for instance.

FIG. 9 illustrates a flowchart of an example of a method 900. The method 900 comprises encrypting 902 data of a first agent with a homomorphic public key. The first agent is connected to a network. The method 900 further comprises transmitting 904 the encrypted data of the first agent and the homomorphic public key to a server. The method 900 further comprises requesting 906 data from the server, the requested data comprising a reference value for the data of the first agent. The reference value being is on the data of the first agent and on the data of one or more second agents, the one or more second agents being connected to the network. The method 900 further comprises receiving 908 the requested data from the server. The requested data is encrypted with the homomorphic public key.

More details and aspects of the method 900 are explained in connection with the proposed technique or one or more examples described above. The examples shown in FIG. 9 may include one or more optional additional features corresponding to one or more aspects mentioned in connection with the proposed concept or one or more examples described above (e.g., FIGS. 1-8).

FIG. 10 illustrates a flowchart of an example of a method 1000. The method 1000 comprises receiving 1002 a request from a first agent to generate data. The requested data comprising a reference value for data of the first agent connected to a network, wherein the reference value being based on the data of the first agent and on data of one or more second agents, the one or more second agents being connected to the network. The method 1000 further comprises receiving 1004 a homomorphic public key and encrypted data of the first agent being encrypted with the homomorphic public key from the first agent. The method 1000 further comprises 1006 determining a list of the one or more second agents being connected to the network. The method 1000 further comprises 1008 transmitting the homomorphic public key to the one or more second agents. The method 1000 further comprises 1010 requesting and receive encrypted data of the one or more second agents. The method 1000 further comprises 1012 generating the requested encrypted data based on the encrypted data of the one or more second agents. The method 1000 further comprises 1014 transmitting the decrypted requested data to the one or more agents.

More details and aspects of the method 1000 are explained in connection with the proposed technique or one or more examples described above. The examples shown in FIG. 10 may include one or more optional additional features corresponding to one or more aspects mentioned in connection with the proposed concept or one or more examples described above (e.g., FIGS. 1-9).

### In the Following, Some Examples of the Proposed Concept are Presented:

An example (e.g., example 1) relates to an apparatus comprising interface circuitry, machine-readable instructions, and processor circuitry to execute the machine-readable instructions to encrypt data of a first agent with a homomorphic public key, wherein the first agent is connected to a network, transmit the encrypted data of the first agent and the homomorphic public key to a server, request data from the server, the requested data comprising a reference value for the data of the first agent, wherein the reference value being based on the data of the first agent and on the data of one or more second agents, the one or more second agents being connected to the network, and receive the requested data from the server, the requested data being encrypted with the homomorphic public key.

Another example (e.g., example 2) relates to a previous example (e.g., example 1) or to any other example, further comprising that the processor circuitry is to execute the machine-readable instructions to decrypt the encrypted requested data from the server with a homomorphic private key, the homomorphic public key and the homomorphic private key forming a homomorphic key pair.

Another example (e.g., example 3) relates to a previous example (e.g., one of the examples 1 to 2) or to any other example, further comprising that the processor circuitry is to execute the machine-readable instructions to transmit the decrypted requested data back data to server.

Another example (e.g., example 4) relates to a previous example (e.g., one of the examples 1 to 3) or to any other example, further comprising that the processor circuitry is to execute the machine-readable instructions to adjust a parameter of the first agent based on the reference value from the server.

Another example (e.g., example 5) relates to a previous example (e.g., one of the examples 1 to 4) or to any other example, further comprising that the processor circuitry is to execute the machine-readable instructions to generate a network identifier, the network identifier identifying all agents being connected to the network and the network identifier being included in the data of first agent.

Another example (e.g., example 6) relates to a previous example (e.g., one of the examples 1 to 5) or to any other example, further comprising that the reference value comprises a value based on a summation of the data of the first agent and on the data of the one or more second agents.

Another example (e.g., example 7) relates to a previous example (e.g., one of the examples 1 to 6) or to any other example, further comprising that the data of the first agent and the data of the one or more second agents indicate a measurement value of a same parameter with respect to the respective agent.

Another example (e.g., example 8) relates to a previous example (e.g., one of the examples 1 to 7) or to any other example, further comprising that the data of the first agent and the data of the one or more second agents comprise a respective signal strength value of a respective signal connection between the respective agent and an access point providing the network.

Another example (e.g., example 9) relates to a previous example (e.g., example 8) or to any other example, further comprising that the reference value is an average value of the signal strength values of the signal connections between the agents and the access point.

Another example (e.g., example 10) relates to a previous example (e.g., one of the examples 1 to 9) or to any other example, further comprising that the network is a network provided by an access point.

Another example (e.g., example 11) relates to a previous example (e.g., example 10) or to any other example, further comprising that processor circuitry is to execute the machine-readable instructions to generate a hash code corresponding to the access point, the hash code identifying all agents connected to the wireless network and the hash code being included in the data of the first agent.

Another example (e.g., example 12) relates to a previous example (e.g., one of the examples 1 to 11) or to any other example, further comprising that the network is a wireless network.

Another example (e.g., example 13) relates to a previous example (e.g., one of the examples 1 to 12) or to any other example, further comprising that the processor circuitry is to execute the machine-readable instructions to generate a random identifier for communication between the first agent and the server.

An example (e.g., example 14) relates to an apparatus comprising interface circuitry, machine-readable instructions, and processor circuitry to execute the machine-readable instructions to receive a request from a first agent to generate data, the requested data comprising a reference value for data of the first agent connected to a network, wherein the reference value being based on the data of the first agent and on data of one or more second agents, the one or more second agents being connected to the network, receive a homomorphic public key and encrypted data of the first agent being encrypted with the homomorphic public key from the first agent, determine a list of the one or more second agents being connected to the network, transmit the homomorphic public key to the one or more second agents, request and receive encrypted data of the one or more second agents, generate the requested encrypted data based on the encrypted data of the one or more second agents, and transmit the decrypted requested data to the one or more agents.

Another example (e.g., example 15) relates to a previous example (e.g., example 14) or to any other example, further comprising that processor circuitry is to execute the machine-readable instructions to transmit the encrypted requested data to the first agent, and receive the decrypted requested data from the first agent.

Another example (e.g., example 16) relates to a previous example (e.g., one of the examples 14 to 15) or to any other example, further comprising that processor circuitry is to execute the machine-readable instructions to add a random number to the encrypted data of the first agent, subtract the random number from the encrypted requested data.

Another example (e.g., example 17) relates to a previous example (e.g., one of the examples 14 to 16) or to any other example, further comprising that the data of the first agent and the data of the one or more second agents comprise a network identifier, the network identifier identifying all agents being connected in the network.

Another example (e.g., example 18) relates to a previous example (e.g., one of the examples 14 to 17) or to any other example, further comprising that the reference value is configured to adjust a parameter of the first agent based on the reference value.

Another example (e.g., example 19) relates to a previous example (e.g., one of the examples 14 to 18) or to any other example, further comprising that the data of the first agent and the data of the one or more second agents comprise a respective signal strength value of a respective signal connection between the respective agent and an access point providing the network.

Another example (e.g., example 20) relates to a previous example (e.g., example 19) or to any other example, further comprising that the reference value is an average value of the signal strength values of the signal connections between the agents and the access point.

An example (e.g., example 21) relates to a system, comprising a first agent comprising the apparatus according to any one of examples 1 to 13, and a server comprising the apparatus according to any one of examples 14 to 20.

An example (e.g., example 22) relates to an apparatus comprising processor circuitry configured to encrypt data of a first agent with a homomorphic public key, wherein the first agent is connected to a network, transmit the encrypted data of the first agent and the homomorphic public key to a server, request data from the server, the requested data comprising a reference value for the data of the first agent, wherein the reference value being based on the data of the first agent and on the data of one or more second agents, the one or more second agents being connected to the network, and receive the requested data from the server, the requested data being encrypted with the homomorphic public key.

An example (e.g., example 23) relates to an apparatus comprising processor circuitry configured to receive a request from a first agent to generate data, the requested data comprising a reference value for data of the first agent connected to a network, wherein the reference value being based on the data of the first agent and on data of one or more second agents, the one or more second agents being connected to the network, receive a homomorphic public key and encrypted data of the first agent being encrypted with the homomorphic public key from the first agent, determine a list of the one or more second agents being connected to the network, transmit the homomorphic public key to the one or more second agents, request and receive encrypted data of the one or more second agents, generate the requested encrypted data based on the encrypted data of the one or more second agents, and transmit the decrypted requested data to the one or more agents.

An example (e.g., example 24) relates to a device comprising means for processing for encrypting data of a first agent with a homomorphic public key, wherein the first agent is connected to a network, transmitting the encrypted data of the first agent and the homomorphic public key to a server, requesting data from the server, the requested data comprising a reference value for the data of the first agent, wherein the reference value being based on the data of the first agent and on the data of one or more second agents, the one or more second agents being connected to the network, and receiving the requested data from the server, the requested data being encrypted with the homomorphic public key.

An example (e.g., example 25) relates to a device comprising means for processing for receiving a request from a first agent to generate data, the requested data comprising a reference value for data of the first agent connected to a network, wherein the reference value being based on the data of the first agent and on data of one or more second agents, the one or more second agents being connected to the network, receiving a homomorphic public key and encrypted data of the first agent being encrypted with the homomorphic public key from the first agent, determining a list of the one or more second agents being connected to the network, transmitting the homomorphic public key to the one or more second agents, requesting and receive encrypted data of the one or more second agents, generating the requested encrypted data based on the encrypted data of the one or more second agents, and transmitting the decrypted requested data to the one or more agents.

An example (e.g., example 26) relates to a method comprising encrypting data of a first agent with a homomorphic public key, wherein the first agent is connected to a network, transmitting the encrypted data of the first agent and the homomorphic public key to a server, requesting data from the server, the requested data comprising a reference value for the data of the first agent, wherein the reference value being based on the data of the first agent and on the data of one or more second agents, the one or more second agents being connected to the network, and receiving the requested data from the server, the requested data being encrypted with the homomorphic public key.

Another example (e.g., example 27) relates to a previous example (e.g., example 26) or to any other example, further comprising that the processor circuitry is to execute the machine-readable instructions to decrypt the encrypted requested data from the server with a homomorphic private key, the homomorphic public key and the homomorphic private key forming a homomorphic key pair.

Another example (e.g., example 28) relates to a previous example (e.g., one of the examples 26 to 27) or to any other example, further comprising that the processor circuitry is to execute the machine-readable instructions to transmit the decrypted requested data back data to server.

Another example (e.g., example 29) relates to a previous example (e.g., one of the examples 26 to 28) or to any other example, further comprising that the processor circuitry is to execute the machine-readable instructions to adjust a parameter of the first agent based on the reference value from the server.

Another example (e.g., example 30) relates to a previous example (e.g., one of the examples 26 to 29) or to any other example, further comprising that the processor circuitry is to execute the machine-readable instructions to generate a network identifier, the network identifier identifying all agents being connected to the network and the network identifier being included in the data of first agent.

Another example (e.g., example 31) relates to a previous example (e.g., one of the examples 26 to 30) or to any other example, further comprising that the reference value comprises a value based on a summation of the data of the first agent and on the data of the one or more second agents.

Another example (e.g., example 32) relates to a previous example (e.g., one of the examples 26 to 31) or to any other example, further comprising that the data of the first agent and the data of the one or more second agents indicate a measurement value of a same parameter with respect to the respective agent.

Another example (e.g., example 33) relates to a previous example (e.g., one of the examples 26 to 32) or to any other example, further comprising that the data of the first agent and the data of the one or more second agents comprise a respective signal strength value of a respective signal connection between the respective agent and an access point providing the network.

Another example (e.g., example 34) relates to a previous example (e.g., example 33) or to any other example, further comprising that the reference value is an average value of the signal strength values of the signal connections between the agents and the access point.

Another example (e.g., example 35) relates to a previous example (e.g., one of the examples 26 to 34) or to any other example, further comprising that the network is a network provided by an access point.

Another example (e.g., example 36) relates to a previous example (e.g., example 35) or to any other example, further comprising that processor circuitry is to execute the machine-readable instructions to generate a hash code corresponding to the access point, the hash code identifying all agents connected to the wireless network and the hash code being included in the data of the first agent.

Another example (e.g., example 37) relates to a previous example (e.g., one of the examples 26 to 36) or to any other example, further comprising that the network is a wireless network.

Another example (e.g., example 38) relates to a previous example (e.g., one of the examples 26 to 37) or to any other example, further comprising that the processor circuitry is to execute the machine-readable instructions to generate a random identifier for communication between the first agent and the server.

An example (e.g., example 39) relates to a method comprising receiving a request from a first agent to generate data, the requested data comprising a reference value for data of the first agent connected to a network, wherein the reference value being based on the data of the first agent and on data of one or more second agents, the one or more second agents being connected to the network, receiving a homomorphic public key and encrypted data of the first agent being encrypted with the homomorphic public key from the first agent, determining a list of the one or more second agents being connected to the network, transmitting the homomorphic public key to the one or more second agents, requesting and receive encrypted data of the one or more second agents, generating the requested encrypted data based on the encrypted data of the one or more second agents, and transmitting the decrypted requested data to the one or more agents.

Another example (e.g., example 40) relates to a previous example (e.g., example 39) or to any other example, further comprising that processor circuitry is to execute the machine-readable instructions to transmit the encrypted requested data to the first agent, and receive the decrypted requested data from the first agent.

Another example (e.g., example 41) relates to a previous example (e.g., one of the examples 39 to 40) or to any other example, further comprising that processor circuitry is to execute the machine-readable instructions to add a random number to the encrypted data of the first agent, subtract the random number from the encrypted requested data.

Another example (e.g., example 42) relates to a previous example (e.g., one of the examples 39 to 41) or to any other example, further comprising that the data of the first agent and the data of the one or more second agents comprise a network identifier, the network identifier identifying all agents being connected in the network.

Another example (e.g., example 43) relates to a previous example (e.g., one of the examples 39 to 42) or to any other example, further comprising that the reference value is configured to adjust a parameter of the first agent based on the reference value.

Another example (e.g., example 44) relates to a previous example (e.g., one of the examples 39 to 43) or to any other example, further comprising that the data of the first agent and the data of the one or more second agents comprise a respective signal strength value of a respective signal connection between the respective agent and an access point providing the network.

Another example (e.g., example 45) relates to a previous example (e.g., example 44) or to any other example, further comprising that the reference value is an average value of the signal strength values of the signal connections between the agents and the access point.

An example (e.g., example 46) relates to a method comprising encrypting data of a first agent with a homomorphic public key, wherein the first agent is connected to a network, transmitting the encrypted data of the first agent and the homomorphic public key to a server, receiving the homomorphic public key and encrypted data of the first agent being encrypted with the homomorphic public key from the first agent requesting data from the server, the requested data comprising a reference value for the data of the first agent, wherein the reference value being based on the data of the first agent and on the data of one or more second agents, the one or more second agents being connected to the network, and receiving the request from the first agent, determining a list of the one or more second agents being connected to the network, transmitting the homomorphic public key to the one or more second agents, requesting and receive encrypted data of the one or more second agents, generating the requested encrypted data based on the encrypted data of the one or more second agents, and transmitting the decrypted requested data to the one or more agents, receiving the requested data from the server, the requested data being encrypted with the homomorphic public key.

Another example (e.g., example 47) relates to a computational system being configured to perform the method any one of examples 26 to 46.

Another example (e.g., example 48) relates to a non-transitory machine-readable storage medium including program code, when executed, to cause a machine to perform the method of any one of examples 26 to 46.

Another example (e.g., example 49) relates to a computer program having a program code for performing the method of any one of examples 26 to 46 when the computer program is executed on a computer, a processor, or a programmable hardware component.

Another example (e.g., example 50) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus comprising interface circuitry, machine-readable instructions, and processor circuitry to execute the machine-readable instructions to:
encrypt data of a first agent with a homomorphic public key, wherein the first agent is connected to a network;
transmit the encrypted data of the first agent and the homomorphic public key to a server;
request data from the server, the requested data comprising a reference value for the data of the first agent,
wherein the reference value being based on the data of the first agent and on the data of one or more second agents, the one or more second agents being connected to the network; and
receive the requested data from the server, the requested data being encrypted with the homomorphic public key.

2. The apparatus of claim 1, wherein the processor circuitry is to execute the machine-readable instructions to decrypt the encrypted requested data from the server with a homomorphic private key, the homomorphic public key and the homomorphic private key forming a homomorphic key pair.

3. The apparatus of claim 1, wherein the processor circuitry is to execute the machine-readable instructions to transmit the decrypted requested data back data to server.

4. The apparatus of claim 1, wherein the processor circuitry is to execute the machine-readable instructions to adjust a parameter of the first agent based on the reference value from the server.

5. The apparatus of claim 1, wherein the processor circuitry is to execute the machine-readable instructions to generate a network identifier, the network identifier identifying all agents being connected to the network and the network identifier being included in the data of first agent.

6. The apparatus of claim 1, wherein the reference value comprises a value based on a summation of the data of the first agent and on the data of the one or more second agents.

7. The apparatus of claim 1, wherein the data of the first agent and the data of the one or more second agents indicate a measurement value of a same parameter with respect to the respective agent.

8. The apparatus of claim 1, wherein the data of the first agent and the data of the one or more second agents comprise a respective signal strength value of a respective signal connection between the respective agent and an access point providing the network.

9. The apparatus of claim 8, wherein the reference value is an average value of the signal strength values of the signal connections between the agents and the access point.

10. The apparatus of claim 1, wherein the network is a network provided by an access point.

11. The apparatus of claim 10, wherein processor circuitry is to execute the machine-readable instructions to generate a hash code corresponding to the access point, the hash code identifying all agents connected to the wireless network and the hash code being included in the data of the first agent.

12. The apparatus of claim 1, wherein the processor circuitry is to execute the machine-readable instructions to generate a random identifier for communication between the first agent and the server.

13. An apparatus comprising interface circuitry, machine-readable instructions, and processor circuitry to execute the machine-readable instructions to:
receive a request from a first agent to generate data, the requested data comprising a reference value for data of the first agent connected to a network,
wherein the reference value being based on the data of the first agent and on data of one or more second agents, the one or more second agents being connected to the network;
receive a homomorphic public key and encrypted data of the first agent being encrypted with the homomorphic public key from the first agent;
determine a list of the one or more second agents being connected to the network;
transmit the homomorphic public key to the one or more second agents;
request and receive encrypted data of the one or more second agents;
generate the requested encrypted data based on the encrypted data of the one or more second agents; and
transmit the decrypted requested data to the one or more agents.

14. The apparatus of claim 13, wherein processor circuitry is to execute the machine-readable instructions to:
transmit the encrypted requested data to the first agent; and
receive the decrypted requested data from the first agent.

15. The apparatus of claim 13, wherein processor circuitry is to execute the machine-readable instructions to:
add a random number to the encrypted data of the first agent;
subtract the random number from the encrypted requested data.

16. The apparatus of claim 13, wherein the data of the first agent and the data of the one or more second agents comprise a network identifier, the network identifier identifying all agents being connected in the network.

17. The apparatus of claim 13, wherein the reference value is configured to adjust a parameter of the first agent based on the reference value.

18. A method comprising:
encrypting data of a first agent with a homomorphic public key, wherein the first agent is connected to a network;
transmitting the encrypted data of the first agent and the homomorphic public key to a server;
requesting data from the server, the requested data comprising a reference value for the data of the first agent,
wherein the reference value being based on the data of the first agent and on the data of one or more second agents, the one or more second agents being connected to the network; and
receiving the requested data from the server, the requested data being encrypted with the homomorphic public key.

19. The method of claim 18, wherein the processor circuitry is to execute the machine-readable instructions to decrypt the encrypted requested data from the server with a homomorphic private key, the homomorphic public key and the homomorphic private key forming a homomorphic key pair.

20. The method of claim 18, wherein the processor circuitry is to execute the machine-readable instructions to transmit the decrypted requested data back data to server.
